(19) United States
(12) Patent Application Publication
(10) Pub. No.: US 2017/0153741 A1
(43) Pub. Date: Jun. 1, 2017

(54) DISPLAY HOVER DETECTION

(71) Applicant: Microsoft Technology Licensing, LLC, Redmond, WA (US)

(72) Inventors: Eyal Ofek, Redmond, WA (US); Michel Pahud, Kirkland, WA (US)

(21) Appl. No.: 14/956,289

(22) Filed: Dec. 1, 2015

(51) Int. Cl. G06F 3/041

(52) U.S. Cl. CPC G06F 3/0416; G06F 2203/04108

(57) ABSTRACT

A camera of a display device may be used to capture images of a hovering finger or stylus. Image processing techniques may be applied to the captured image to sense right-left position of the hovering finger or stylus. To measure distance to the hovering finger or stylus from the camera, a pattern may be displayed by the display so that the hovering finger or stylus is illuminated by a particular portion or color of the pattern over which the finger or stylus hovers. The image processing techniques may be used to determine, from the captured image, which particular portion or color of the pattern illuminates the finger or stylus. This determination, in conjunction with the known displayed pattern, may provide the 3D location or the distance to the hovering finger or stylus from the camera.

### BACKGROUND

The popularity of smartphones, tablets, and many types of information appliances is driving demand and acceptance of touchscreens and other displays for portable and functional electronics. Touchscreens and other displays are found, among other places, in the medical field and in heavy industry, as well as in automated teller machines (ATMs), and kiosks such as museum displays or room automation, where keyboard and mouse systems do not allow a suitably intuitive, rapid, or accurate interaction by the user with the display's content.

In contrast to sensing touch or other physical contact by a user, hover sensing involves sensing a non-touch or pre-touch interaction of a finger or stylus with a surface, such as a display. In this case, a finger or stylus need not physically contact the surface.

### SUMMARY

A front-facing camera of a display device (e.g., handheld smartphone or tablet) may, in some techniques, be fitted with a tilted mirror to sense and locate hover of an object, such as a finger or a stylus of a user relative to a display of the device. In some examples, a tilted mirror may redirect the view of the front facing camera toward a region just above the display of the device. The mirror could be flat, curved, and the like. Using image processing techniques, images of a hovering object (herein referred to as a finger or stylus in various examples) captured by the camera may then be used to sense right-left and/or up-down positions of the hovering finger or stylus. To measure distance to the hovering finger or stylus from the camera, a pattern, which may be a pattern of colors, is displayed by the display so that the hovering finger or stylus is illuminated by a particular portion or color of the pattern over which the finger or stylus hovers. The image processing techniques may be used to determine, from the captured image, which particular portion or color of the pattern illuminates the finger or stylus. This determination, in conjunction with the known displayed pattern, may provide the distance to the hovering finger or stylus from the camera. In some examples, this determination, in conjunction with other known displayed patterns, may provide the three-dimensional (3D) location of the hovering finger or stylus.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs)), and/or other technique(s) as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example environment in which techniques described herein may be implemented.

FIG. 2 is a top view of an example display device.

FIG. 3 is a side view of an example display device.

FIG. 4 is a side view of an example display device that includes a tilted mirror.

FIG. 5 is a block diagram of an example system that includes an image processing module.

FIG. 6 is a top view of an example pattern of a continuum of colors displayed by a display.

FIG. 7 is a top view of an example pattern of discrete colors displayed by a display.

FIG. 8 is a top view of a finger hovering over an example pattern displayed by a display.

FIG. 9 is a side view of fingers hovering over an example pattern displayed by a display.

FIG. 10 illustrates an example image captured by a camera.

FIG. 11 is a side view of a stylus hovering over an example pattern displayed by a display.

FIG. 12 is a top view of a finger hovering over an example pattern including an illuminated spot displayed by a display.

FIG. 13 is a side view of a finger hovering over an example pattern including an illuminated spot displayed by a display.

FIGS. 14A and 14B compare top views of an example pattern of discrete colors displayed by a display without augmented reality modification and with augmented reality modification, respectively.

FIG. 15 is a top view of a finger hovering over an example resolution-changeable pattern displayed by a display.

FIG. 16 is a flow diagram of an example process for operating a user interface.

### DETAILED DESCRIPTION

Rather than using a mouse, touchpad, or any other intermediate device, some display devices may enable a user to interact directly with display content (e.g., windows, menus, text, drawings, icons, images, and so on) that are displayed. In some examples, a display device may comprise a touchscreen that can sense and locate physical touch of an object (e.g., finger(s), stylus(es), and so on) on the display of the display device. In other examples, a display device may be configured to sense an object (e.g., finger(s), stylus, and so on) hovering above the display device.

For example, a touchscreen may include an input device layered on top of an electronic visual display of an information processing system. A user may provide input or control the information processing system during a touch event using single or multi-touch gestures by touching the display with one or more stylus(es)/pen(s), one or more fingers, one or more hands, or other body parts. The user may, for example, use the touch display to react to what is displayed and to control how content is displayed (for example by expanding (zooming) the text size, selecting menu items or objects, and so on). Herein, a touch event may involve physical touch between an object (e.g., the user's finger(s) or hand(s)) and the touchscreen.

In some configurations, if a finger of a user (or other object) touches a touchscreen, a “touchdown” event may be produced by an application programming interface (API). This event may be responsive to the finger having physically touched the touchscreen. In some configurations, the event may involve information that may allow a processor, for example, to determine where on the touchscreen the touchdown event occurred. In some examples, if an object (finger, stylus, ‘Joystick’, etc.) touches a surface, the view of the object above the surface may be used to add modality for the touch, such as tilt of the object, a bend of a soft stylus proportional to pressure applied, and so on.

In other examples, a display may be configured to sense one or more stylus(es)/pen(s), one or more fingers, one or more hands, or other body parts or objects hovering above the display, where physical contact with the display or other surface need not be involved. Hereinafter, a hovering one or more stylus(es)/pen(s), one or more fingers, one or more hands or other body part or object is hereinafter called a hover object (e.g., “object” in this context is a catch-all phrase that includes anything that may hover over a surface). A hover generally involves a hover object that is relatively close to (e.g., a few millimeters, a few centimeters or more, though claimed subject matter is not so limited) a surface, such as the surface of a display or the surface of a touchscreen, without touching the surface. In some cases, such a surface need not be a display. In some examples, a hover may involve one or more fingers or a side of a hand in a particular orientation above a surface or passing over a portion of the surface. Claimed subject matter is not limited in this respect.

In some examples, the term “hover,” (sometimes called “3D touch”) is used to describe a condition where an object is positioned in front of, but not in contact with, the front surface of the display, and is within a predetermined 3D space or volume in front of the display. Accordingly, a hovering object may be defined as an object positioned in front of the display of the computing device within the predetermined 3D space without actually contacting the front surface of the display. The dimensions of the 3D space where hover interactions are constrained, and particularly a dimension that is perpendicular to the front surface of the display, may depend on the size of the display and/or the context in which the display used, as will be described in more detail below.

It is to be appreciated that, no matter the device type, sensors, or context of use, “hover,” as used herein, may reference a physical state of an object that is positioned within a predetermined 3D space in front of the display without actually contacting the front surface of the display. The dimensions of the predetermined 3D space may be defined by a two-dimensional (2D) area on the display and a distance in a direction perpendicular to the front surface of the display. In this sense, objects that are positioned outside of the 2D area on the display, contacting the display, or beyond a threshold distance in a direction perpendicular to the front surface of the display may be considered to not be in a hover state.

In some examples, a system may be able to sense objects that are not directly above a display, but instead may be a bit offset. Such ability to sense may be due, at least in part, to light from the display that illuminates (e.g., reflects from) the offset objects. Such an ability to sense may allow for sensing fingers, for example, that are holding a phone or tablet (e.g., the system). In some implementations, in situations where light reflecting from an object is not visible, such as if the object is too far toward a side of the display, for example, the system may use information from past samples (e.g., velocity of hovering object) to predict where the object is located or will be located. Such a prediction may also be used to verify (e.g., if the prediction matches) the view from the camera(s) of the system without using any light reflecting from the object or without using the view from the camera(s).

A display (e.g., touch-sensitive or hover-sensing) may be used in devices such as game consoles, personal computers, tablet computers, smartphones, large displays, and so on. A display may be attached to a computer(s) or used as a client device (e.g., as terminals) for networks. A display may be integrated in the design of digital appliances such as personal digital assistants (PDAs), global positioning system (GPS) navigation devices, mobile phones, video games, electronic books (E-books), and so on.

Various examples describe techniques and architectures for a system enabled to (among other things) detect and locate a hover object. For example, a system may determine the location of an object hovering over a display. The determination of the location may include determining the location in three-dimensions (3D location) relative to the display. For example, a system associated with a display may determine the location of a hover object in a 3D orthogonal coordinate system (e.g., X, Y, and Z axes) relative to the display. In some examples, the system may determine the orientation of the hover object relative to the display. In still other examples, the system may determine the locations of the hover object at more than one time, and thus be able to determine speed or velocity of the hover object.

In various configurations, a “system” may be considered to include any combination of things. For example, in some configurations, a system may be considered to be a display and a processor. In other examples, a system may include memory, an image processor module, and a display. Claimed subject matter is not limited in this respect.

In some example configurations, actions of the system may be based, at least in part, on the determination of location or speed/velocity of a hover object. For example, the system may predict a touchdown (e.g., timing and/or location thereof) by the hover object. The system may resultantly modify at least one element displayed by a display (e.g., any display of the system, including a display other than the display over which the hover object is located) in response to such a touchdown prediction and/or location. Herein, the phrase “modifying at least one element displayed by a display” refers to a display changing what (e.g., windows, menus, icons, graphical objects, text, and so on) or how (e.g., brightness and/or contrast of particular portions of the touchscreen) the display displays the element(s) or display background, though claimed subject matter is not limited in this respect. In some examples, a system may modify behavior of a user interface associated with the display using information regarding the location of the hover object. Such behavior that may be modified includes, program execution (e.g., shifting execution from one set of codes to another set of codes (sub-routines), displaying elements (as mentioned above), and generating haptic output (e.g., to an element in contact with a user of virtual reality), just to name a few examples.

Hover sensing may be useful for systems involved with a virtual reality (VR) or augmented reality (AR) headset. For example, a user of a VR headset may not be able to see their fingers above a display. Though a system may render an image on a virtual display in a virtual world, sensing a real hover object (e.g., an object that has not physically contacted a surface such as a touchscreen) may require additional processes. Such processes may involve sensing an object (e.g., a finger or stylus) while the object hovers above the surface, prior to an actual touch.

Some example implementations may sense and locate hover objects without involving capacitive hover sensing techniques, which may be relatively difficult to achieve and may increase system costs. Such example implementations instead may involve a relatively simple, accurate, and efficient technique for detecting hover sensing. For example, a front-facing camera, which may be configured with a tilted mirror, may be used to capture images of one or more hover object(s). A system may analyze the captured images to, among other things, sense the hover object and to determine the location of the hover object.

In some examples, a display comprises a screen that illuminates light, which need not be in the visible spectrum. For instance, near-IR may be used to sense hover of a finger above a touch surface, without any visual display.

In examples herein, though an element, such as a hover object, finger, camera, processor, and so on, may be stated in the singular, claimed subject matter is not so limited. Thus for example, unless otherwise stated, more than one of such elements may be implied.

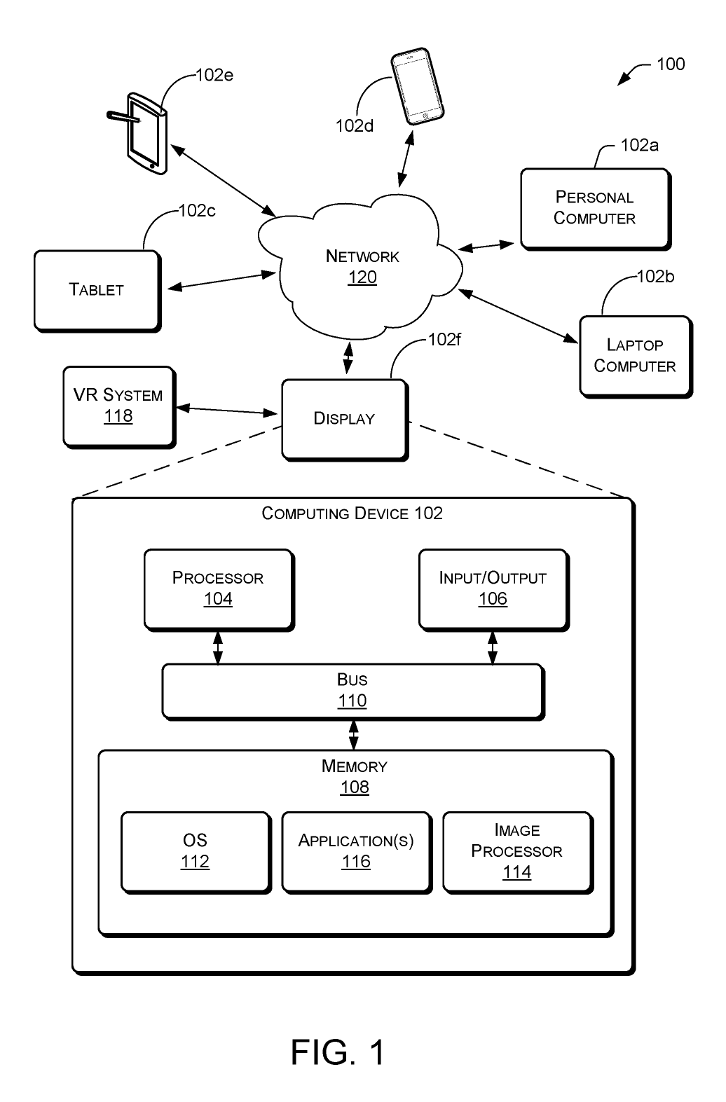

Various examples are described further with reference to FIGS. 1-16.

The environment described below constitutes but one example and is not intended to limit the claims to any one particular operating environment. Other environments may be used without departing from the spirit and scope of the claimed subject matter.

FIG. 1 illustrates an example environment 100 in which example processes as described herein can operate. In some examples, the various devices and/or components of environment 100 include a variety of computing devices 102. By way of example and not limitation, computing devices 102 may include devices 102a-102f. Although illustrated as a diverse variety of device types, computing devices 102 can be other device types and are not limited to the illustrated device types or numbers of each device type. Computing devices 102 can comprise any type of device with one or multiple processors 104 operably connected to an input/output interface 106 and memory 108, e.g., via a bus 110. Computing devices 102 can include personal computers such as, for example, desktop computers 102a, laptop computers 102b, tablet computers 102c, telecommunication devices 102d, personal digital assistants (PDAs) 102e, a display 102f, electronic book readers, wearable computers, automotive computers, gaming devices, measurement devices, etc. Computing devices 102 can also include business or retail oriented devices such as, for example, server computers, thin clients, terminals, and/or work stations. In some examples, computing devices 102 can include, for example, components for integration in a computing device, appliances, or other sorts of devices.

Herein, unless specifically noted, “processor” may include one or more processors. Processor 104, for example, may be used to operate display 102f. For example, processor 104 may execute code to allow display 102f to display objects generated by any of a number of applications or services, which may also be executed by processor 104. Memory 108, which may be local (e.g., hard-wired in packaging of display 102f and processor 104) or remote (e.g., in a wired or wireless computer network), accessible to processor 104, which may store such executable code or applications.

In some examples, some or all of the functionality described as being performed by computing devices 102 may be implemented by one or more remote peer computing devices, a remote server or servers, or a cloud computing resource.

In some examples, as shown regarding display 102f, memory 108 can store instructions executable by the processor 104 including an operating system (OS) 112, an image processor 114, and programs or applications 116 that are loadable and executable by processor 104. The one or more processors 104 may include one or more central processing units (CPUs), graphics processing units (GPUs), video buffer processors, and so on. In some implementations, image processor 114 comprises executable code stored in memory 108 and is executable by processor 104 to collect information, locally or remotely by computing device 102, via input/output 106. The information may be associated with one or more of applications 116. Image processor 114 may selectively apply any of a number of examples of colors, optical textures, images, and patterns, just to name a few examples, stored in memory 108 to apply to input data (e.g., captured images). For example, image processing may be involved in processes involving processor 104 interpreting or determining images of hovering objects based, at least in part, on information stored in memory 108.

In some examples, one or more AR systems and/or VR systems 118 may be associated with display 102f. For example, VR system 118 may respond, at least in part, to objects hovering over or touching display 102f or other type of surface, such as a reflective colored or patterned surface.

Though certain modules have been described as performing various operations, the modules are merely examples and the same or similar functionality may be performed by a greater or lesser number of modules. Moreover, the functions performed by the modules depicted need not necessarily to be performed locally by a single device. Rather, some operations could be performed by one or more remote device(s) (e.g., peer, server, cloud, etc.).

Alternatively, or in addition, some or all of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In some examples, computing device 102 can be associated with one or more camera(s) capable of capturing images and/or video and/or one or more microphone(s) capable of capturing audio. For example, input/output module 106 can incorporate such camera(s) and/or microphone(s). Captured images of hover objects over a display, for example, may be compared to images in a database of various objects and/or materials illuminated by any of a number of display patterns stored in memory 108, and such comparing may be used, in part, to identify the hover objects. Memory 108 may include one or a combination of computer readable media.

Computer readable media may include computer storage media and/or communication media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media embodies computer readable instructions, data structures, program modules, and/or other data in a modulated data signal, such as a carrier wave, and/or other transmission mechanism. As defined herein, computer storage media does not include communication media. In various examples, memory 108 is an example of computer storage media storing computer-executable instructions. When executed by processor 104, the computer-executable instructions configure the processor 104 to, among other things, drive a display to display a pattern having features located in particular locations on the display; receive an image from a camera, the image including an object hovering above the display and at least partially illuminated by at least one of the features of the pattern; determine a location of the object based, at least in part, on the location of the at least one feature of the pattern; and use information regarding the location of the object to modify behavior of a user interface (e.g., such as in VR system 118) associated with the display.

In various examples, an input device of input/output (I/O) interfaces 106 can be one or more indirect input devices (e.g., a mouse, keyboard, a camera or camera array, etc.), or another type of non-tactile device, such as an audio input device.

Computing device(s) 102 may also include one or more input/output (I/O) interfaces 106 to allow the computing device 102 to communicate with other devices. Input/output (I/O) interfaces 106 can include one or more network interfaces to enable communications between computing device 102 and other networked devices such as other device(s) 102. Input/output (I/O) interfaces 106 can allow a device 102 to communicate with other devices such as user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like).

In some implementations any of a number of computing devices 102 may be interconnected via a network 120. Such a network may include one or more data centers that store and/or process information (e.g., data) received from and/or transmitted to computing devices 102, for example.

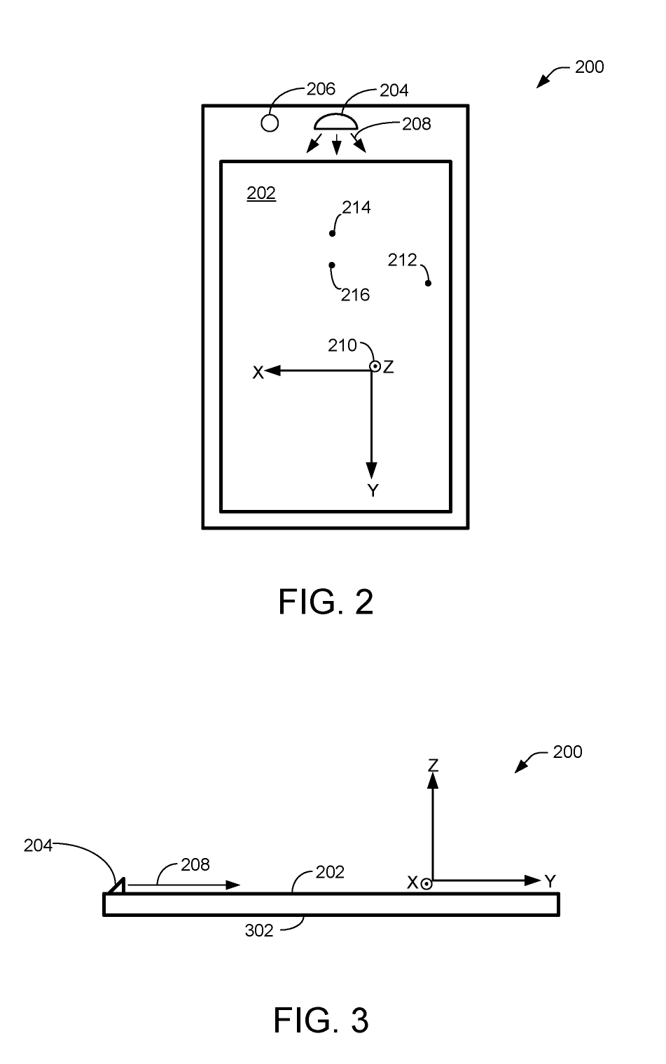

FIG. 2 is a top or front view of an example display device 200, which includes a display 202, a camera 204, and a light sensor 206. FIG. 2 includes an orthogonal coordinate system comprising X, Y, and Z axes, where X and Y axes describe a plane parallel with display 202, and the Z-axis is perpendicular to the display (e.g., in the direction that “protrudes” out from the figure), as indicated by a circled dot 210.

Camera 204 may provide images to a processor, such as processor 104, for example, associated with display device 200. Such images may also (or instead) be provided to an image processor, such as image processor 114. Light sensor 206 may provide measurements of intensity and/or spectral information (e.g., spectrum of the ambient light) to the processor. Such measurements may also (or instead) be provided to the image processor. In some examples, light sensor 206 may comprise a photodiode, phototransistor, photocell, and/or other light-sensitive device. In some examples, a system may use measurements provided by light sensor 206 regarding ambient light in the region around display device 200. The system may adjust any of a number of features (e.g., resolution, brightness, colors, and so on) of displayed patterns, described below, in response to measured ambient light.

Camera 204 may be similar to or the same as a front-facing camera that may be found on any of a number of types of display devices, such as smart phones, tablets, and so on. Arrows 208 indicate the direction of view of camera 204. For example, camera 204 may be configured to capture images (or a number of images such as for a video) in a region above display 202, such as a direction substantially parallel with the X-Y plane. As further explained below, a position or location of an object in an image captured by camera 204 may be relatively easy to detect along the X-axis and the Z-axis. In other words, the position of an object may be relatively discernable in directions transverse to the direction of view (e.g., the Y-axis) of camera 204. On the other hand, a position or location of an object in an image captured by camera 204 may be relatively difficult to detect along the Y-axis. Thus, for example, the location difference between a hover object at point 212 and another hover object at point 214 may be relatively easy to detect in an image captured, since the location difference is substantially along a direction (X-axis) transverse to the direction (Y-axis) of view of camera 204. In contrast, the location difference between the hover object at point 214 and another hover object at point 216 may be relatively difficult to detect in an image captured, since the location difference is substantially along a direction (Y-axis) parallel to the direction (Y-axis) of view of camera 204. Techniques described herein may be used to determine locations of hover objects along the direction of view of camera 204, for example.

FIG. 3 is a side view of the example display device 200 described above for FIG. 2. The side view illustrates the back 302 of display device 200. Camera 204 may protrude from the front surface of the display device 200 so as to have a view 208 of the region above display 202. In some configurations, camera 204 may comprise a pop-up option, where camera 204 may be able to rotate to a protruding orientation (e.g., as illustrated) or to an orientation that is flush with the surface of display device 200, for example.

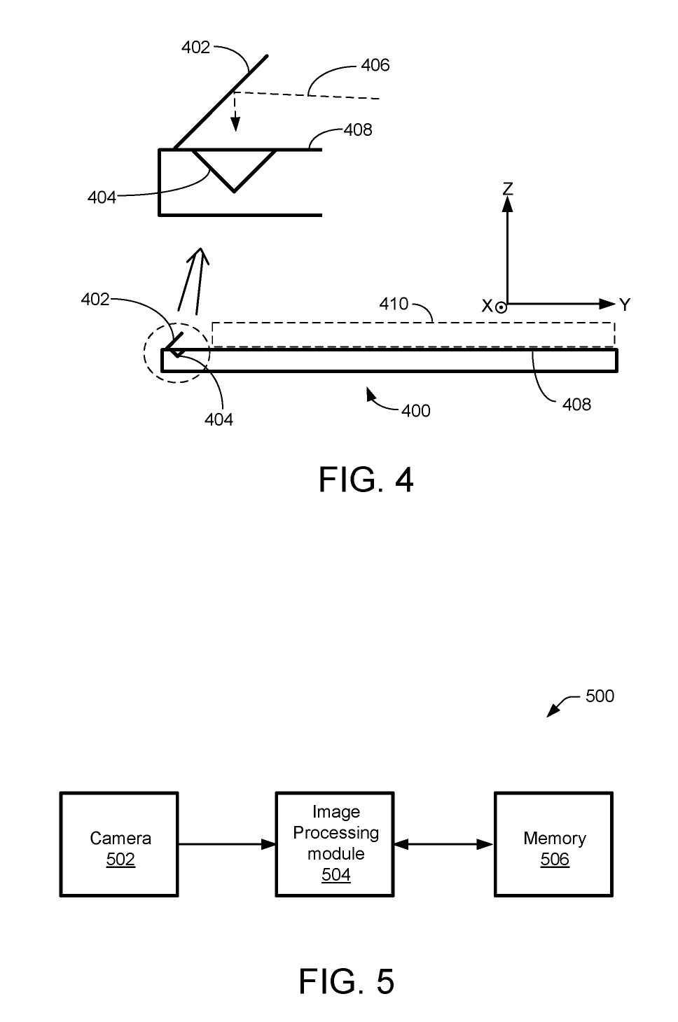

FIG. 4 is a side view and close-up view of an example display device 400 that includes a tilted mirror 402 associated with a camera 404. Display device 400 may be similar to or the same as display device 200 except that camera 404 may be a rear-facing (not illustrated) or front-facing (e.g., facing along the Z-axis) camera, whereas camera 204 may be a down-facing (e.g., facing along the Y-axis) camera. In some examples, mirror 402 may be added as an accessory to the display device 400. For instance, mirror 402 may be clipped onto a display device such as a smartphone. Mirror 402 may be useful for enabling display devices having front-facing cameras to perform techniques described herein for sensing hover objects. In some examples, a removable camera may be an accessory that is able to communicate with a device such as display device 200.

Mirror 402 may be a flat mirror, a curved mirror that can extend the view of the camera to the corners of the display, or a rotated mirror (e.g., such that when not in use the mirror need not block the camera or protrude out of the device).

In detail, light (e.g., image information) 406 originating from a region above display 408 may be reflected by mirror 402 to be redirected toward camera 404. Herein, “region above the display” refers to a region within a distance of a few centimeters or more above the surface of a display. Such a distance may depend, at least in part, on the size of the display. For example, for a relatively small display (e.g., hand-held size display), the distance may be about 2 or 3 centimeters. For relatively large displays (e.g., desktop or table- or board-mounted), the distance may be decimeters or more. Such a region is roughly indicated schematically by dashed rectangle 410, though this region is not necessarily shown to scale with other portions of FIG. 4.

FIG. 5 is a block diagram 500 of an example system that includes a camera 502, an image processing module 504, and a memory 506. For example, camera 502 may be the same as or similar to camera 204 or 404. Image processor module 504 may be the same as or similar to image processor module 114. In some examples, camera 502 may capture images (e.g., data representative of images) that are subsequently provided to image processor module 504, which may analyze features of hover objects in the images. For example, image processor module 504 may quantify (e.g., measure) positions, orientations, colors, and brightness of hover objects in the image. In some cases, image processor module 504 may discriminate among textures of hover objects based on optical characteristics of the hover objects. For example, a hover object (e.g., a stylus) having a smooth metallic surface may appear brighter in the image as compared to a hover object having a grooved or textured surface. For another example, a hover object (e.g., a finger) having a beige-colored surface may appear different and distinguishable in the image as compared to a hover object (e.g., a stylus) having a smooth metallic surface. Image processor module 504 may access memory 506, which may store a database of image data including optical characteristics of materials and textures of candidate hover objects. Thus, for example, image processor module 504 may identify a hover object and access memory 506 in a process of identifying the type of hover object. In some examples, image processor module 504 may use machine learning or similar techniques to perform such identifying. In this fashion, image processor module 504 may determine whether a hover object is a stylus, a finger, or other object. Such techniques performed by image processor module 504 may be extended to more than one hover object in an image.

In some examples processes, location of a hover object may be determined by color, gray-level, brightness, and/or or other features of a pattern on a display that illuminates the hover object, as described in detail below. Accordingly, the ability of image processor module 504 to quantify or distinguish among colors or other optical characteristics may be applied to such processes. The pattern may be represented as “location data”, which may comprise information stored in memory about the pattern (e.g., the locations of the particular features/colors of the pattern relative to the display.

In some configurations, subsequent to determining location of a hover object, a system may modify any of a number of features or objects displayed by a display. Such features or objects may include, among other things, windows, menus, icons, brightness and/or contrast of particular portions of the touchscreen, graphical objects, text, and so on.

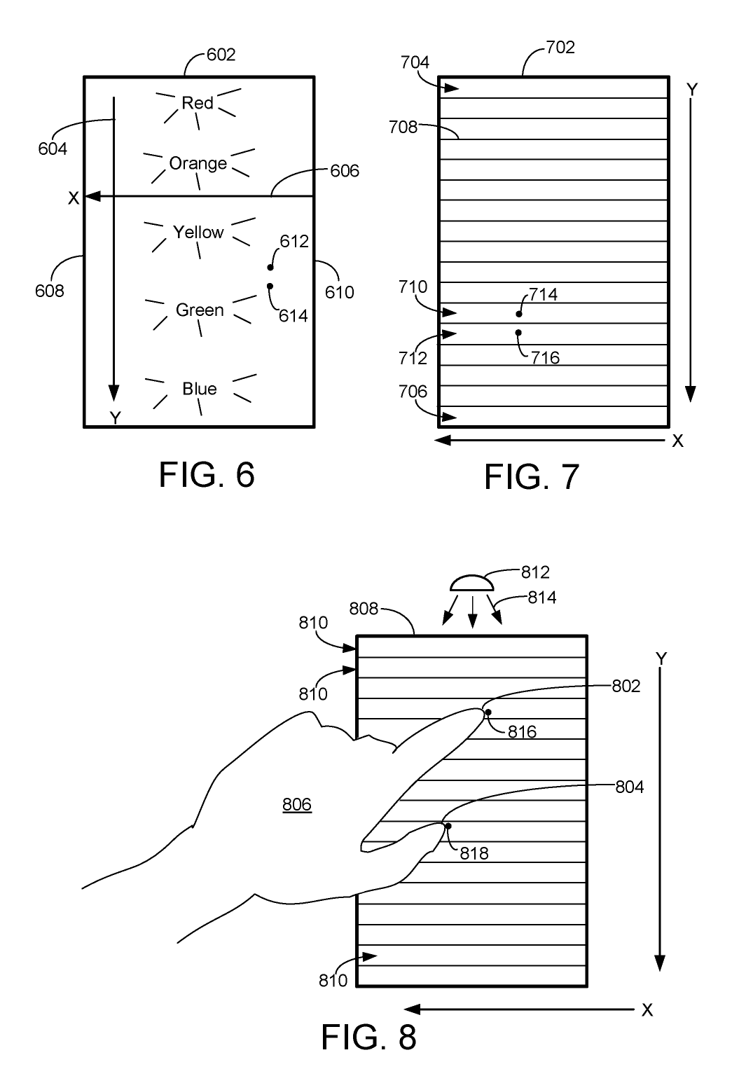

FIG. 6 is a top view of an example pattern of a continuum of colors displayed by a display 602 of a system. For example, display 602 may be the same as or similar to display 202 or 408. Such a pattern may be displayed so that a hover object, as captured in an image, may be detected and its location measured based, at least in part, on the color that illuminates the hover object. For example, if the hover object is hovering over an orange part of a pattern, then the hover object may be illuminated by orange. Since the system a priori knows the location of orange in the pattern, the system may infer the location of the hover object. Such a color pattern may comprise colors that change in the Y-direction and need not change in the X-direction. This is because the location of a hover object along the X-direction is relatively easy to determine without using a pattern, so colors (or the pattern) need not change in this direction. On the other hand, the location of a hover object along the Y-direction (e.g., in the direction of view of a camera) may be determined using a pattern, so colors (or the pattern) changes in this direction. In some examples, the location of the hover object along the X-direction and/or the Z-direction (e.g., transverse to the direction of view of the camera) may also be determined using a pattern, and claimed subject matter is not limited in this respect.

A fine variation in displayed color, such as that used to represent an orange color by alternating red and yellow pixels, may be used to recover not only the position along the display, but also another measurement of the height above the display. For example, when a finger is very close to the display, it is possible to see the difference between the red and yellow pixels in the light on the finger, while if the finger is further away, the color of the finger is a blur of the pixels, and appears orange. Thus resolution of color rendering may be used for detection.

The continuum of colors may begin and end with any of a number of colors over any distance. In the example illustrated, color transition from the top of display 602, which is red, to the bottom of display 602, which is blue, follows the visible spectrum in a continuous manner in the Y-direction indicated by arrow 604. Individual colors (or more specifically, individual color ranges) may extend in the X-direction indicated by arrow 606 from side 610 to side 608. Resolution of the pattern may be based on color range (e.g., wavelength range) per distance in the Y-direction. For example, if the red-most color of display 602 has a wavelength of 650 nanometers (nm), and the blue-most color of the display has a wavelength of 450 nm, then the resolution may be 20 nm per centimeter, if display 602 is 10 centimeters long. Resolution may be doubled, for example, if the same 200 nm spectrum were displayed over half of display 602.

In some examples, displays, which may be relatively large, may include two or more consecutive regions of red-to-blue patterns (e.g., as described above). Such regions may allow for the size of a hover object(s), such as a finger, to disambiguate the region for a given color seen below the hover object(s). In some examples that take into account technical details of a camera(s), colors for which a camera has relatively low sensitivity may be displayed closer to the camera as compared to other colors of a pattern.

As mentioned above, location of a hover object may be determined by color or other features of a pattern on a display that illuminates the hover object. The ability of an image processor module, such as 504, to quantify or distinguish among colors or other optical characteristics may depend, at least in part, on resolution of the pattern, precision (e.g., optics) of camera 502, size or shape of the hover object, and reflectivity of the hover object, just to name a few examples. For instance, a hover object over point 612 may be illuminated by that portion of the pattern, which may be yellowish-green at 520 nm. A hover object over point 614 may be illuminated by that portion of the pattern, which may also be yellowish-green, but at 510 nm. Thus, the ability of a system to determine whether the hover object is over point 612 or point 614 may depend on the ability of the optical system (e.g., including the camera and image processor module) to distinguish between 510 nm and 520 nm. Continuing with this example, if the optical system can distinguish between 510 nm and 520 nm (e.g., the optical system has a detection resolution of 10 nm), then the system (e.g., optical system, processor, display, etc.) can determine the location of a hover object along the Y-direction to within 0.5 centimeters if the color resolution is 20 nm per centimeter.

FIG. 7 is a top view of an example pattern of discrete color bands displayed by a display 702 of a system. For example, display 702 may be the same as or similar to display 202 or 408. Such a pattern may be displayed so that a hover object, as captured in an image, may be detected and its location measured based, at least in part, on the color that illuminates the hover object. Since the system a priori knows the location of colors in the pattern, the system may infer the location of the hover object.

The discrete color bands may begin and end with any of a number of colors over any distance. In the example illustrated, a color band 704 is at the top of display 702, and a color band 706 is at the bottom of display 702. Individual color bands may extend in the X-direction. Resolution of the pattern may be based on number of color bands per distance in the Y-direction. For example, 17 color bands are illustrated in FIG. 7. Each such color band may be about 0.5 centimeters wide for a display that is about 10 centimeters long. The number of color-bands (and/or other features of the bands) included in a pattern may correspond to optical resolution and optical detection capabilities of the system (in addition to, for example, characteristics of the display, such as brightness). For example, if an optical system can distinguish among 20 colors, then 20 color bands (of different colors) may be included in a pattern. (A greater number of bands may adversely affect detection ability by reducing relative intensity of a color that illuminates a hover object. A lesser number of bands may adversely affect detection by reducing precision (e.g., increasing granularity) of location measurements of a hover object.)

In some examples, a fairly small number of bands may lead to a capability of detecting hover object(s) by tracking a split line between colors of a pattern below the hover object(s). For example, if a green band is followed by a blue band, the color below a hover object may be entirely green when exactly over the green band, and may become green with a small amount of blue when moving along the Y-direction, subsequently becoming more blue, and so on.

In some implementations, transitions 708 between adjacent color bands may be relatively sharp such that, for example, the transition from one color to another occurs over a distance of less than about a millimeter or so, just to mention a particular numerical example. Each color band may be a color having a wavelength range of about 10 or 20 nm wide (e.g., full width at half max (FWHM)). For example, color band 710 may be the color green, with a wavelength range from about 460 nm to 470 nm and color band 712 may be the color greenish-blue, with a wavelength range from about 450 nm to 460 nm. There may be wavelength overlap between adjacent color bands or there may be wavelength separation between adjacent color bands.

As mentioned above, location of a hover object may be determined by color or other features of a pattern on a display that illuminates the hover object. For instance, a hover object over point 714 may be illuminated by that portion of the pattern, which may be green at about 465 nm. A hover object over point 716 may be illuminated by that portion of the pattern, which may also be greenish-blue, at about 455 nm. The ability of a system to determine whether the hover object is over point 714 or point 716 may depend on the ability of the optical system (e.g., including the camera and image processor module) to distinguish between 455 nm and 465 nm. (In some examples, a pattern may comprise interlaced colors of relatively highly different wavelength (e.g., blue followed by red).) Continuing with this example, if the optical system can distinguish between adjacent color bands (e.g., 455 nm and 465 nm), then the system (e.g., optical system, processor, display, etc.) can determine the location of a hover object within the width of individual color bands.

FIG. 8 is a top view of fingers 802 and 804 (herein, a thumb is referred to as a finger, unless otherwise specified) of a user's hand 806 hovering over an example pattern displayed by a display 808 of a system. For example, the pattern may be the same as or similar to color patterns illustrated in either of FIG. 6 or 7. Accordingly, the pattern may include color bands 810, each having a color different from the others in the pattern. A camera 812, which may be the same as or similar to camera 204 or 404, may have a view direction 814, to capture images of hover objects (e.g., fingers 802 and 804) in a region above display 808.

In some examples, a camera(s) mounted on a head display of a VR or AR system may be used to resolve occlusion involving fingers and/or other hover objects, such as in the case where one finger may block another finger in the view of one or more cameras.

Location in the Y-direction of fingers 802 and 804 may be determined by color or other features of the pattern on display 808 that illuminates the fingers. For example, finger 802 over point 816 may be illuminated by the color of that portion of the pattern. Finger 804 over point 818 may be illuminated by the color of that portion of the pattern. In detail, camera 812 may capture an image of fingers 802 and 804 hovering over display 808. The captured image may be provided to an image processing module of the system that is able to determine the color of illumination of each of fingers 802 and 804. Information about the color of illumination may then be provided to a processor of the system that may compare this information with a priori known information about the displayed pattern. From such a comparison, the processor may determine the location in the Y-direction of fingers 802 and 804.

In some examples, the location in the Y-direction of fingers 802 and/or 804 may change and the system may measure to determine a number of features based, at least in part, on such a location change. For example, speed or velocity of the fingers may be determined by considering the location change and the time span for the location change to occur. In other examples, the system may detect user actions such as pinch motion of hover objects (e.g., in air, not necessarily in contact with a surface) to affect zoom or other displayed objects. In still other examples, the system may detect user actions such as hand or finger rotation in air (e.g., change of relative position of the fingers) to affect rotation of displayed objects. Herein, “in air” refers to a situation where physical contact with a surface need not occur.

Though a finger of hand 806 is illustrated as a hover object, examples include cases where more than one finger, a side or back of a hand, or the thumb may be a hover object, and claimed subject matter is not limited in this respect.

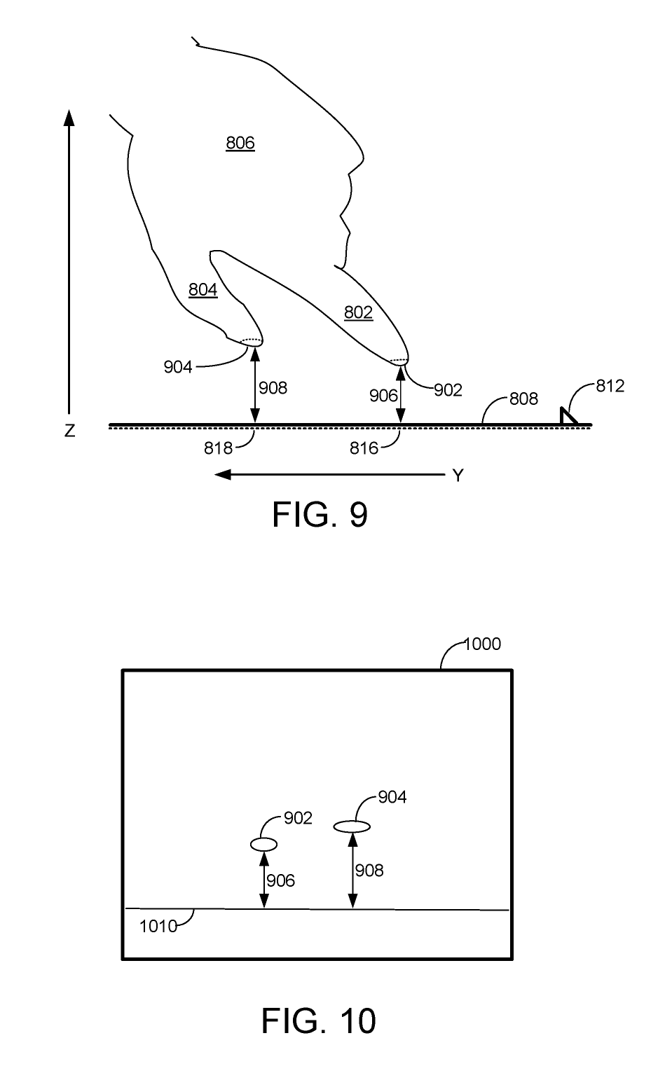

FIG. 9 is a side view of fingers 802 and 804 hovering over the pattern displayed by display 808 of the system, as discussed in FIG. 8. Location in the Y-direction of fingers 802 and 804 may be determined by color or other features of the pattern on display 808 that illuminates the fingers. For example, illumination 902 is illustrated on finger 802 over point 816. Illumination 902 may be the color of that portion of the pattern (combined with skin tone, texture, etc.). Illumination 904 is illustrated on finger 804 over point 818. Illumination 904 may be the color of that portion of the pattern (combined with skin tone, texture, etc.).

Accordingly, as described above, camera 812 may capture an image of fingers 802 and 804 hovering over display 808. The captured image may be provided to an image processing module of the system that is able to determine the color of illumination 902 and 904 of each of fingers 802 and 804, respectively. Information about the color of illumination may then be provided to a processor of the system that may compare this information with a priori known information about the displayed pattern. From such a comparison, the processor may determine the location in the Y-direction of fingers 802 and 804. On the other hand, the system need not consider the pattern to measure distances 906 and 908 in the Z-direction. Instead, the image processing module may determine distances 906 and 908 by analyzing images of fingers 802 and 804 captured by camera 812. In some examples, intensity of portions of images may be used by the image processing module to determine height of a hover object above a surface.

In some examples, the location in the Y-direction of fingers 802 and 804 may change and the system may measure to determine a number of features based, at least in part, on such a location change. For example, speed or velocity of the fingers may be determined by considering the location change and the time span for the location change to occur. In other examples, the system may detect user actions such as pinch motion in air to affect zoom or other displayed objects. In still other examples, the system may detect user actions such as hand or finger rotation in air (e.g., change of relative position of the fingers) to affect rotation of displayed objects.

FIG. 10 illustrates an image 1000 captured by a camera such as 812, for example. The image, which does not necessarily include all objects that may be in the image, depicts the example situation illustrated in FIGS. 8 and 9. For example, the image includes the surface 1010 of display 808, illumination 902 of finger 802, and illumination 904 of finger 804. An image processing module may determine the colors of illumination 902, illumination 904, and their respective distances 906 and 908 from the surface 1010 of the display.

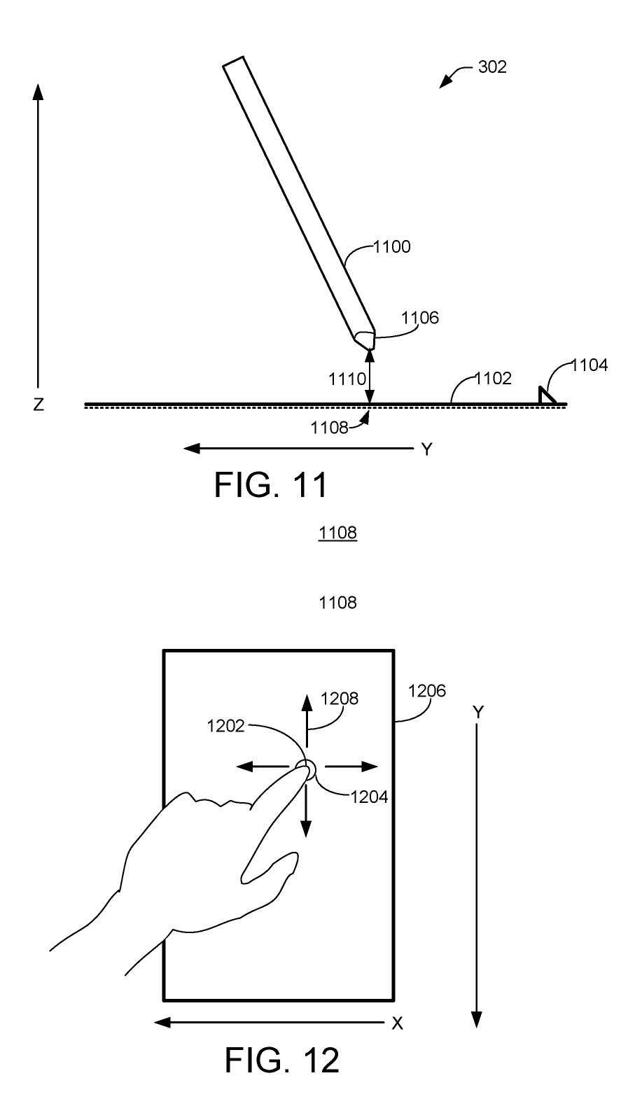

FIG. 11 is a side view of a stylus 1100 hovering over an example pattern displayed by a display 1102. This situation is similar to that described for fingers above (e.g., FIGS. 8-10). Location in the Y-direction of stylus 1100 may be determined by color or other features of the pattern on display 1102 that illuminates the stylus. In some cases, the surface of stylus 1100 (or a bottom portion thereof) may have a quality or texture that scatters a relatively large amount of light so that illumination by the displayed pattern is visible in images captured by camera 1104. For example, illumination 1106 is illustrated on stylus 1100 over point 1108 of the displayed pattern. Illumination 1106 may be the color of that portion of the pattern (combined with the color of the stylus, texture, etc.).

Accordingly, as described above, camera 1104 may capture an image of stylus 1100 hovering over display 1102. The captured image may be provided to an image processing module of the system that is able to determine the color of illumination 1106. Information about the color of illumination may then be provided to a processor of the system that may compare this information with a priori known information about the displayed pattern. From such a comparison, the processor may determine the location in the Y-direction of the stylus. On the other hand, the system need not consider the pattern to measure a distance 1110 in the Z-direction. Instead, the image processing module may determine the distance 1110 by analyzing images of stylus 1100 captured by camera 1104.

FIG. 12 is a top view of a finger 1202 hovering over an example pattern that includes an illuminated spot 1204 displayed by a display 1206 of a system. Though one finger is described, the following examples may apply to two or more fingers. This situation may be similar to those described above, except that the displayed pattern comprises a relatively bright spot with a dark background instead of a color pattern, for example. (In other examples, the displayed pattern may comprise a relatively dark spot with a bright background.) In some implementations, illuminated spot 1204 may have a nominal size in a range from about a millimeter to about a centimeter, for example. In other implementations, illuminated spot 1204 may have a nominal size (e.g., size or shape/orientation) based, at least in part, on the height and/or orientation of the finger. In yet other implementations, the intensity of a bright spot may be modified based, at least in part, on the height of the object above the display.

The system may dynamically alter the display by moving illuminated spot 1204 in response to movement of finger 1202. For example, initial conditions may be that finger 1202 is hovering over a portion of display 1206 that does not include illuminated spot 1204. The system, however, may systematically scan display 1206 by moving illuminated spot 1204 relatively rapidly (e.g., with respect to motion of finger 1202) and sequentially across all “rows” of the display. At some point in time, illuminated spot 1204 will be relatively close and under finger 1202. When this occurs, finger 1202 may be illuminated by illuminated spot 1204 and this may be detected in an image captured by a camera of the system. Also when this occurs, the system may determine the hover location of finger 1202 since this location is the same as the location of illuminated spot 1204 (which the system displays at particular pixel coordinates, for example).

As hovering finger 1202 moves across display 1206, illuminated spot 1204 tracks and follows the finger by responding to relatively rapid sampling of brightness of illumination of the finger. For example, if finger moves away from illuminated spot 1204, brightness of illumination of the finger, as detected in captured images, may decrease. When this occurs, the system may move the illuminated spot 1204 in any of a number of directions (any angles, including X and Y-directions), indicated by arrows 1208, for example. When the brightness of illumination of the finger increases again, then the system has detected the new position (and possibly projection and speed) of the moving finger. By using such a trial and error movement, the system repeatedly moves illuminated spot 1204 to track movement of finger 1202.

In some examples, when the finger is moving away from illuminated spot 1204, the system may predict to where the finger is moving based, at least in part, on the way light is changing underneath of finger. In other examples, a display may include patterns other than those described. For example, any of a number of display geometries and patterns may be used to track a hover object by detecting brightness of illumination from a portion of the displayed pattern. Claimed subject matter is not so limited.

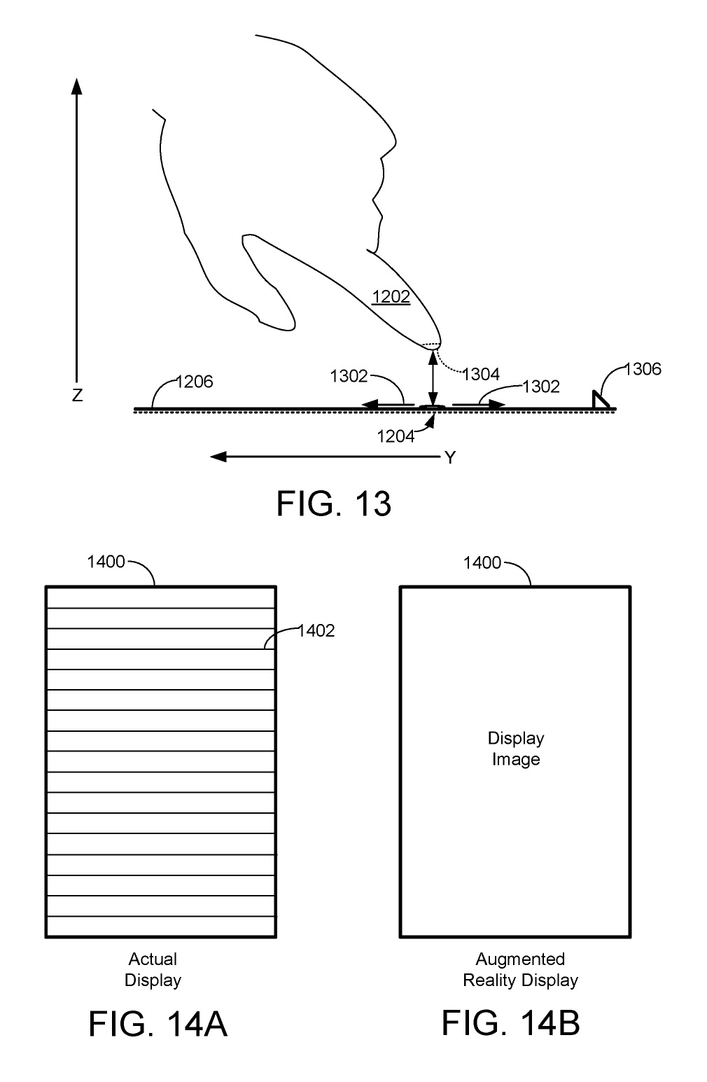

FIG. 13 is a side view of finger 1202 hovering over the example pattern including illuminated spot 1204 displayed by display 1206. The system, as mentioned above, may systematically scan display 1206 by moving illuminated spot 1204 relatively rapidly (e.g., with respect to motion of finger 1202) and sequentially across all “rows” of the display, as indicated by arrows 1302. At some point in time, illuminated spot 1204 will be relatively close and under finger 1202. When this occurs, finger 1202 may be illuminated by illuminated spot 1204 and consequently include a bright portion 1304, which is a scattering of light impinging on finger 1202 from illuminated spot 1204. This scattered light may be detected in an image captured by camera 1306 of the system. Also when this occurs, the system may determine the hover location of finger 1202 since this location is the same as the location of illuminated spot 1204 (which the system displays at particular pixel coordinates, for example).

As hovering finger 1202 moves (or continues to move) across display 1206, illuminated spot 1204 tracks and follows the finger by responding to relatively rapid sampling of the intensity of bright portion 1304. For example, if finger moves away from illuminated spot 1204, intensity of bright portion 1304, as detected in captured images, may decrease. When this occurs, the system may move the illuminated spot 1204 in any of a number of directions, indicated by arrows 1208, for example. When the intensity of bright portion 1304 increases again, then the system has detected the new position (and possibly projection and speed) of the moving finger. By using such a trial and error movement, the system repeatedly moves illuminated spot 1204 to track movement of finger 1202.

FIGS. 14A and 14B compare top views of an example pattern of discrete colors displayed by a display 1400 without augmented reality modification and with augmented reality modification, respectively. In some examples, techniques described herein may involve AR or VR systems. For example, display 1400 may include a display image that comprises a discrete color pattern 1402, the same as or similar to the pattern illustrated in FIG. 7, for example. In some examples, a user of an augmented reality system may be wearing controllably transparent eyewear that includes an intrinsic display. Thus, the user may view display 1400 through such eyewear. Without such eyewear, the user may see an actual image displayed on display 1400. This actual image may comprise discrete color pattern 1402. Looking through the eyewear, however, the user may see a virtual image on display 1400. This virtual image may be generated by the augmented reality system and may replace discrete color pattern 1402. In this case, hover sensing of hover objects (e.g., the user's fingers) may be used by the augmented reality system to include images of the fingers in the virtual image. Accordingly, the user effectively sees their fingers in their correct locations on display 1400, but does not see discrete color pattern 1402. In some examples involving AR, if hover object(s) are tracked, the real hover object(s) may be displayed while rendering the image below the display of the device (e.g., not rendering the image over the hover object(s)).

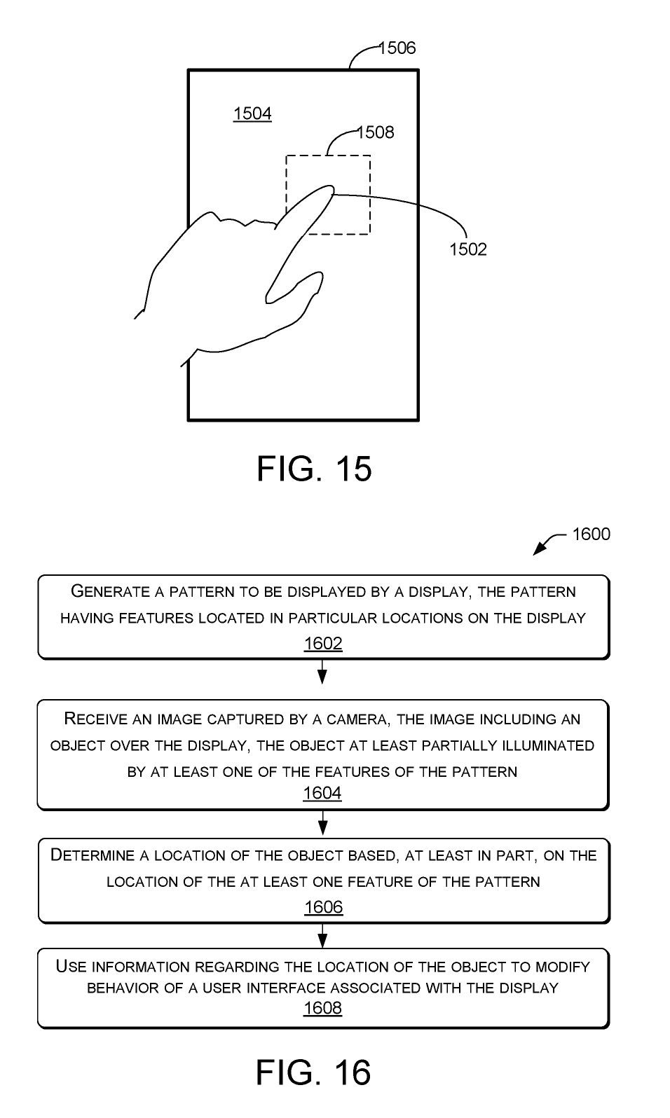

FIG. 15 is a top view of a finger 1502 hovering over an example resolution-changeable pattern 1504 displayed by a display 1506. As mentioned above, a displayed color pattern (or other pattern, such as a geometrical pattern) may have a particular resolution. Such a resolution may be the highest that can be achieved by a system having a particular optical resolution (e.g., for discriminating among different colors) or by a display having finite size (e.g., there may be a limited number of different colors that can fit in the display). The accuracy or precision with which a system may determine a location of a hover object over a displayed pattern may be based, at least in part, on the resolution of the pattern. For example, as the resolution of the pattern increases, so does the accuracy or precision with which the system may determine the location of a hover object.

In some examples, a system may change the resolution of pattern 1504 in portions of display 1506. For example, the system may increase the resolution of pattern 1504 in portion 1508 while leaving the resolution of the remaining portions of pattern 1504 unchanged. Such a resolution increase in portion 1508 may be in response to the system determining that finger 1502 is located in portion 1508. In other words, portion 1508 may be defined by, and centered about, the location of finger 1502. Thus, with such an increase in the resolution of the pattern, the accuracy or precision with which the system may determine the location of finger 1502 may increase.

FIG. 16 is a flow diagram of an example process 1600 for operating a user interface. Process 1600 may be performed by a processor, for example. For example, process 1600 may be performed by computing device 102, illustrated in FIG. 1. At block 1602, the processor may generate a pattern to be displayed by a display. The pattern may have features located in particular locations on the display, for example.

At block 1604, the processor may receive an image captured by a camera. The image may include an object over the display. The object may be at least partially illuminated by at least one of the features of the pattern. At block 1606, the processor may determine a location of the object based, at least in part, on the location of the at least one feature of the pattern. At block 1608, the processor may use information regarding the location of the object to modify behavior of a user interface associated with the display.

The flow of operations illustrated in FIG. 16 is illustrated as a collection of blocks and/or arrows representing sequences of operations that can be implemented in hardware, software, firmware, or a combination thereof. The order in which the blocks are described is not intended to be construed as a limitation, and any number of the described operations can be combined in any order to implement one or more methods, or alternate methods. Additionally, individual operations may be omitted from the flow of operations without departing from the spirit and scope of the subject matter described herein. In the context of software, the blocks represent computer-readable instructions that, when executed by one or more processors, configure the processor to perform the recited operations. In the context of hardware, the blocks may represent one or more circuits (e.g., FPGAs, application specific integrated circuits—ASICs, etc.) configured to execute the recited operations.

Any process descriptions, elements, or blocks in the flows of operations illustrated in FIG. 16 may represent modules, segments, or portions of code that include one or more executable instructions for implementing specific logical functions or elements in the process.

A. A system comprising: a display operable by one or more processors; a camera configured to capture images of a region above the display; and a memory storing instructions that, when executed by the one or more processors, cause the one or more processors to perform operations comprising: driving the display to display a pattern having features located at particular locations on the display; receiving an image from the camera, the image including a representation of an object hovering above the display and at least partially illuminated by at least one of the features of the pattern; determining a location of the object relative to the display based, at least in part, on the particular location of the at least one feature of the pattern; and using information regarding the location of the object to modify behavior of a user interface associated with the display.

B. The system as paragraph A recites, wherein the pattern comprises a continuum of colors and the features are subsets of the continuum of colors.

C. The system as paragraph A recites, wherein the pattern comprises discretely located color bands and the features are individual color bands.

D. The system as paragraph A recites, wherein the pattern covers substantially the entire display.

E. The system as paragraph A recites, wherein the stored instructions, when executed by the one or more processors, cause the one or more processors to perform operations comprising: subsequent to determining the location of the object, increasing resolution of the pattern in an area of the display corresponding to a projection of the object onto the display.

F. The system as paragraph A recites, wherein the object comprises a finger of a user or a stylus.

G. The system as paragraph A recites, wherein the stored instructions, when executed by the one or more processors, cause the one or more processors to perform operations comprising: comparing the location of the object to a previously determined location of the object to infer a direction of motion or a speed of the object.

H. The system as paragraph G recites, wherein the stored instructions, when executed by the one or more processors, cause the one or more processors to perform operations comprising: predicting a touch event based, at least in part, on the direction of motion or the speed of the object.

I. The system as paragraph A recites, further comprising an augmented display device, and wherein the stored instructions, when executed by the one or more processors, cause the one or more processors to perform operations comprising: generating a virtual image on the augmented display device to replace the pattern on the display.

J. A hover-sensing input device comprising: a display in a plane defined by a first direction and a second direction orthogonal to the first direction, the display facing a third direction that is orthogonal to the first direction and the second direction; a processor to generate a pattern to be displayed by the display; an image processing module communicatively coupled to the processor to receive location data corresponding to the pattern; and a camera aimed substantially in the first direction, the camera to provide an image to the image processing module, wherein the image processing module is configured to: identify, in the image, a portion of the pattern that is at least partially reflected from an object hovering over the display; and provide the portion of the pattern to the processor; and wherein the processor is configured to: determine a location of the object in the first direction and the second direction by comparing the location data corresponding to the portion of the pattern.

K. The hover-sensing input device as paragraph J recites, wherein the processor is configured to: compare the location of the object to a previously determined location of the object to infer a direction of motion or a speed of the object.

L. The hover-sensing input device as paragraph L recites, wherein the pattern comprises a background and an illumination spot that is contrasted with the background, and wherein the processor is configured to: move the illumination spot to a new location of the pattern in response to the direction of motion or the speed of the object.

M. The hover-sensing input device as paragraph J recites, further comprising a light sensor to measure ambient light, wherein the processor is configured to adjust the pattern based, at least in part, on the ambient light.

N. The hover-sensing input device as paragraph J recites, wherein the image processing module is configured to: identify a texture or a material of the object by comparing the portion of the pattern identified in the image to a database of textures or materials.

O. The hover-sensing input device as paragraph J recites, wherein the image processing module is configured to: identify, in the image, a second portion of the pattern that is at least partially reflected from a second object hovering over the display; and provide the second portion of the pattern to the processor; and wherein the processor is configured to: determine a location of the second object in the first direction and the second direction by comparing the location data corresponding to the pattern to the second portion of the pattern.

P. The hover-sensing input device as paragraph J recites, wherein the processor is communicatively coupled to a virtual reality system to provide the location of the object to the virtual reality system.

Q. A method comprising: generating a pattern to be displayed by a display, the pattern having features located in particular locations on the display; receiving an image captured by a camera, the image including a representation of an object positioned over the display, the object at least partially illuminated by at least one of the features of the pattern; determining a location of the object relative to the display based, at least in part, on the location of the at least one feature of the pattern; and using information regarding the location of the object to modify behavior of a user interface associated with the display.

R. The method as paragraph Q recites, wherein the user interface associated with the display comprises a virtual reality system.

S. The method as paragraph Q recites, further comprising displaying the pattern intermittently for a period that is i) too short for the human vision system to substantially perceive the pattern or (ii) less than about 10 milliseconds.

T. The method as paragraph Q recites, wherein the user interface comprises a virtual reality system, and the behavior comprises haptic generation.

Although the techniques have been described in language specific to structural features and/or methodological acts, it is to be understood that the appended claims are not necessarily limited to the features or acts described. Rather, the features and acts are described as example implementations of such techniques.

Unless otherwise noted, all of the methods and processes described above may be embodied in whole or in part by software code modules executed by one or more general purpose computers or processors. The code modules may be stored in any type of computer-readable storage medium or other computer storage device. Some or all of the methods may alternatively be implemented in whole or in part by specialized computer hardware, such as FPGAs, ASICs, etc.

Conditional language such as, among others, “can,” “could,” “might” or “may,” unless specifically stated otherwise, are used to indicate that certain examples include, while other examples do not include, the noted features, elements and/or steps. Thus, unless otherwise stated, such conditional language is not intended to imply that features, elements and/or steps are in any way required for one or more examples or that one or more examples necessarily include logic for deciding, with or without user input or prompting, whether these features, elements and/or steps are included or are to be performed in any particular example.

Conjunctive language such as the phrase “at least one of X, Y or Z,” unless specifically stated otherwise, is to be understood to present that an item, term, etc. may be either X, or Y, or Z, or a combination thereof.

Many variations and modifications may be made to the above-described examples, the elements of which are to be understood as being among other acceptable examples. All such modifications and variations are intended to be included herein within the scope of this disclosure.

What is claimed is:

1. A system comprising:
a display operable by one or more processors;
a camera configured to capture images of a region above the display; and
a memory storing instructions that, when executed by the one or more processors, cause the one or more processors to perform operations comprising:
driving the display to display a pattern having features located at particular locations on the display;
receiving an image from the camera, the image including a representation of an object hovering above the display and at least partially illuminated by at least one of the features of the pattern;
determining a location of the object relative to the display based, at least in part, on the particular location of the at least one feature of the pattern; and
using information regarding the location of the object to modify behavior of a user interface associated with the display.

2. The system of claim 1, wherein the pattern comprises a continuum of colors and the features are subsets of the continuum of colors.

3. The system of claim 1, wherein the pattern comprises discretely located color bands and the features are individual color bands.

4. The system of claim 1, wherein the pattern covers substantially the entire display.

5. The system of claim 1, wherein the stored instructions, when executed by the one or more processors, cause the one or more processors to perform operations comprising:
subsequent to determining the location of the object, increasing resolution of the pattern in an area of the display corresponding to a projection of the object onto the display.

6. The system of claim 1, wherein the object comprises a finger of a user or a stylus.

7. The system of claim 1, wherein the stored instructions, when executed by the one or more processors, cause the one or more processors to perform operations comprising:
comparing the location of the object to a previously determined location of the object to infer a direction of motion or a speed of the object.

8. The system of claim 7, wherein the stored instructions, when executed by the one or more processors, cause the one or more processors to perform operations comprising:
predicting a touch event based, at least in part, on the direction of motion or the speed of the object.

9. The system of claim 1, further comprising an augmented display device, and wherein the stored instructions, when executed by the one or more processors, cause the one or more processors to perform operations comprising:
generating a virtual image on the augmented display device to replace the pattern on the display.

10. A hover-sensing input device comprising:
a display in a plane defined by a first direction and a second direction orthogonal to the first direction, the display facing a third direction that is orthogonal to the first direction and the second direction;
a processor to generate a pattern to be displayed by the display;
an image processing module communicatively coupled to the processor to receive location data corresponding to the pattern; and
a camera aimed substantially in the first direction, the camera to provide an image to the image processing module, wherein the image processing module is configured to:
identify, in the image, a portion of the pattern that is at least partially reflected from an object hovering over the display; and
provide the portion of the pattern to the processor; and
wherein the processor is configured to:
determine a location of the object in the first direction and the second direction by comparing the location data corresponding to the portion of the pattern.

11. The hover-sensing input device of claim 10, wherein the processor is configured to:
compare the location of the object to a previously determined location of the object to infer a direction of motion or a speed of the object.

12. The hover-sensing input device of claim 11, wherein the pattern comprises a background and an illumination spot that is contrasted with the background, and wherein the processor is configured to:
move the illumination spot to a new location of the pattern in response to the direction of motion or the speed of the object.

13. The hover-sensing input device of claim 10, further comprising a light sensor to measure ambient light, wherein the processor is configured to adjust the pattern based, at least in part, on the ambient light.

14. The hover-sensing input device of claim 10, wherein the image processing module is configured to:
identify a texture or a material of the object by comparing the portion of the pattern identified in the image to a database of textures or materials.

15. The hover-sensing input device of claim 10, wherein the image processing module is configured to:
identify, in the image, a second portion of the pattern that is at least partially reflected from a second object hovering over the display; and
provide the second portion of the pattern to the processor; and
wherein the processor is configured to:
determine a location of the second object in the first direction and the second direction by comparing the location data corresponding to the pattern to the second portion of the pattern.

16. The hover-sensing input device of claim 10, wherein the processor is communicatively coupled to a virtual reality system to provide the location of the object to the virtual reality system.

17. A method comprising:
generating a pattern to be displayed by a display, the pattern having features located in particular locations on the display;
receiving an image captured by a camera, the image including a representation of an object positioned over the display, the object at least partially illuminated by at least one of the features of the pattern;
determining a location of the object relative to the display based, at least in part, on the location of the at least one feature of the pattern; and
using information regarding the location of the object to modify behavior of a user interface associated with the display.

18. The method of claim 17, wherein the user interface associated with the display comprises a virtual reality system.

19. The method of claim 17, further comprising displaying the pattern intermittently for a period that is i) too short for the human vision system to substantially perceive the pattern or (ii) less than about 10 milliseconds.

20. The method of claim 17, wherein the user interface comprises a virtual reality system, and the behavior comprises haptic generation.
